(19) United States
(12) Patent Application Publication
(10) Pub. No.: US 2006/0136900 A1
(43) Pub. Date: Jun. 22, 2006

(54) Devices and methods for updating program code via a serial ata interface

(75) Inventors: Hang-ro Kim, Seoul (KR); Hyung-nam Byun, Gyeonggi-do (KR); Chul-min Kim, Gyeonggi-do (KR); Myoung-su Song, Seoul (KR)

Correspondence Address: MYERS BIGEL SIBLEY & SAJOVEC, PO BOX 37428, RALEIGH, NC, 27627, US

(73) Assignee: Samsung Electronics Co., Ltd

(21) Appl. No.: 11/301,368

(22) Filed: Dec. 13, 2005

(30) Foreign Application Priority Data
Dec. 17, 2004 (KR) 10-2004-0107992

(51) Int. Cl. G06F 9/44

(52) U.S. Cl. 717/168

(57) ABSTRACT

An apparatus and method update a program code of an electronic device, such as an optical disk drive, using a Serial Advanced Technology Attachment (SATA) interface. The apparatus receives SATA signals from the SATA interface and generates flash memory driving signals based on a register host-to-device FIS received from a host computer system. Furthermore, the apparatus receives program data from a data host-to-device FIS received from the host computer system and updates the program code of a flash memory in the electronic device.

### CROSS-REFERENCE TO RELATED APPLICATION

This application claims priority under 35 U.S.C. § 119 from Korean Patent Application No. 10-2004-0107992, filed on Dec. 17, 2004, in the Korean Intellectual Property Office, the disclosure of which is hereby incorporated by reference herein in its entirety.

### FIELD OF THE INVENTION

The present invention relates to electronic devices, and, more particularly, to devices and methods for updating program code in electronic devices.

### BACKGROUND OF THE INVENTION

Optical disk drives, such as CD-ROM (Compact Disc Read-Only Memory) drives and/or other digital optoelectronic memory storage equipment, may be included in many personal computer systems. In personal computers, CD-ROM drives were generally designed for the storage of mass information on CD-ROM disks. However, even though CD-ROM has been adopted by the ISO (International Standards Organization) as a standard for digital data storage, other applications beyond the storage of large amounts of data have also been proposed. More particularly, under proper software control, a CD-ROM drive may also be used to access several other types of disks in the compact disc (CD) family.

For example, in personal computer systems, CD-ROM drives may be configured to be used for playing music CDs, video CDs (VCDs) and/or Digital Versatile Discs (DVDs). Thus, the CD-ROM drive may be programmed to access different formats of the CD family of media in a manner known as software driver installation. With the installation of the proper software drivers, the computer system can be used to read data files stored on the CD-ROM, and/or playback music and/or video stored thereon. These software drivers may essentially be established on top of the hardware-level control programs that may reside in a control system of the CD-ROM drive. This “firmware” may usually be stored in non-volatile semiconductor memory devices, such as erasable-programmable read-only memory (EPROM), electrically erasable-programmable read-only memory (EEPROM) and/or flash memory.

If the firmware has any problems and/or program bugs, the firmware stored in the semiconductor devices may be upgraded. In other words, the firmware may be replaced by another copy without the problems. Conventional methods for updating firmware codes using erasable and programmable memory devices are disclosed in U.S. Pat. Nos. 5,968,141 and 6,754,765.

For example, U.S. Pat. No. 5,968,141 discloses systems for updating the firmware code of an optical disk drive via an IDE (Integrated Drive Electronics) interface. More particularly, as shown in FIG. 1, electronic drive control circuitry 30 includes a multiplexer (MUX) 36 coupled between a micro-controller 33 and a memory 34 configured to store firmware code. In addition to the decoding performed by a CD-ROM decoder 31, a programming controller (PRG CNTL) 32 is used to control the multiplexer 36 to selectively connect the memory 34 either to the micro-controller 33 in a normal mode of operation, or to an ATA/IDE (Advanced Technology Attachment/Integrated Drive Electronics) bus 10 for connection with a host processor in a firmware upgrade mode of operation. The programming controller 32 includes circuitry for converting IDE interface signals into flash memory signals, as shown in FIG. 2, in order to connect the memory 34 to the ATA/IDE bus 10 of the optical disk drive in the firmware upgrade mode. More specifically, the programming controller 32 includes an I/O address decoder (ADDR DEC) 321, an upgrade initialization key enable logic (I.KEY EN) 322, an address program enable latch (APEN LATCH) 323, a data program enable latch (DPEN LATCH) 324, and a control program enable latch (CPEN LATCH) 325.

In addition, U.S. Pat. No. 6,754,765 discloses a flash memory controller including a program memory and a data memory. As shown in FIG. 3, the flash memory controller 100 includes an SRAM-type program memory 105 configured for storing micro-codes to be executed by a micro-controller 104, and a data memory 106 including reference tables for monitoring bad data blocks in a flash memory 140. A host computer 130 is configured to load an initial code to the program memory 105. Subsequently, newly updated micro-codes downloaded to the controller 100 are stored in the flash memory 140.

However, such conventional methods for updating firmware codes may use relatively complicated hardware to generate the flash memory signals for updating the firmware and/or micro-codes, which may be undesirable.

### SUMMARY OF THE INVENTION

According to some embodiments of the present invention, an apparatus for updating program code in an electronic device using Serial Advanced Technology Attachment (SATA) may include an SATA interface, a first memory, a command decoder, a second memory interface, and a second memory. The SATA interface may be connected to a host, and may be configured to receive input signals comprising a register host-to-device FIS (frame information structure) and a data host-to-device FIS from the host. The first memory may be connected to the SATA interface and may be configured to store program data obtained from the data host-to-device FIS transmitted from the host. The command decoder may be connected to the SATA interface and may be configured to interpret information obtained from the register host-to-device FIS transmitted from the host. The second memory interface may be configured to generate signals for driving the second memory in response to an output of the command decoder based on the register host-to-device FIS. The second memory may be configured to be updated with the program data stored in the first memory in response to the driving signals of the second memory interface.

In some embodiments, the second memory interface may include a key generator, a control signal generator, an address generator, and a data generator. The key generator may be configured to decode feature information of the register host-to-device FIS to generate an upgrade initialization key signal. The control signal generator may be configured to decode control information of the register host-to-device FIS to generate control signals. The address generator may be configured to decode sector number information of the register host-to-device FIS to generate address signals. The data generator may be connected to the first memory and may be configured to generate data signals from the program data stored in the first memory.

According to other embodiments of the present invention, a method for updating program code in an electronic device using SATA may include receiving SATA signals from the SATA interface; decoding the SATA signals to determine whether a host computer system requests an upgrade of the program code; receiving a register host-to-device FIS and a data host-to-device FIS from the host computer system when the host computer system requests the upgrade of the program code; storing data of the data host-to-device FIS in a first memory; generating second memory driving signals in response to the register host-to-device FIS; and writing the data of the data host-to-device FIS stored in the first memory in a second memory in response to the second memory driving signals.

Accordingly, some embodiments of the present invention may be configured to generate flash memory driving signals from the register host-to-device FIS using the SATA interface of the host computer system, and may be configured to receive program data from the data host-to-device and/or device-to-host FIS to update the program code of the flash memory.

### BRIEF DESCRIPTION OF THE DRAWINGS

FIG. 1 is a block diagram of conventional drive control electronic circuitry used for updating firmware code of an optical disk drive via an IDE interface;

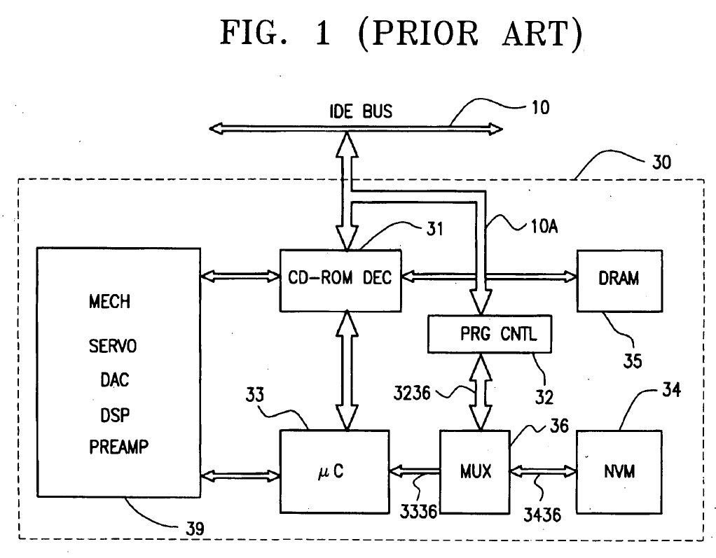

FIG. 2 is a circuit diagram of the programming controller of FIG. 1;

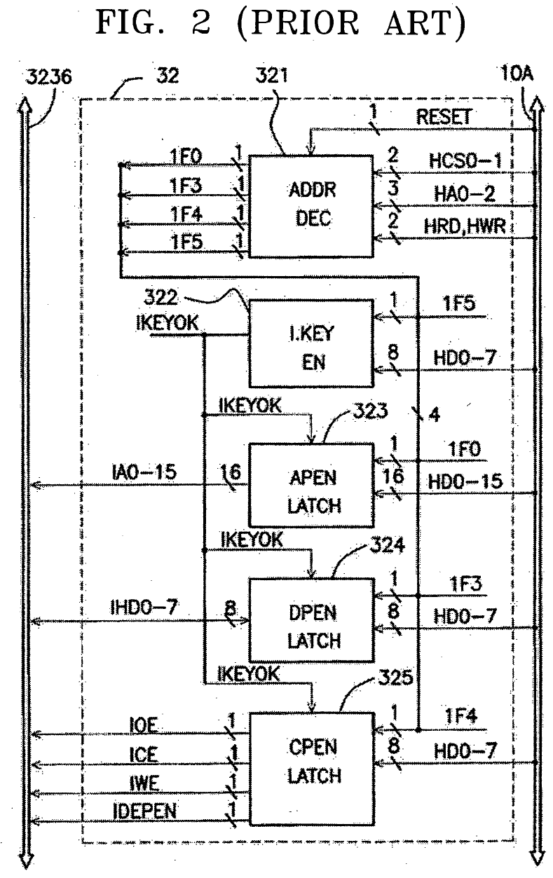

FIG. 3 is a block diagram of a conventional flash memory controller having a program memory and a data memory;

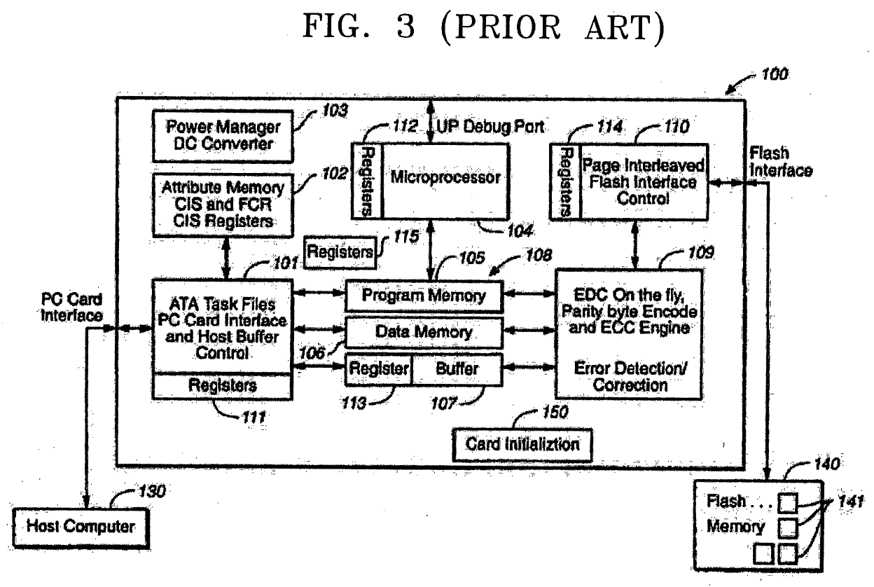

FIG. 4 is a block diagram of an apparatus for updating program code in an electronic device using a SATA interface according to some embodiments of the present invention;

FIG. 5 illustrates the transmission sequence of SATA protocol;

FIG. 6 illustrates the layout of register host-to-device FIS in SATA protocol;

FIG. 7 illustrates the layout of data host-to-device or device-to-host FIS in SATA protocol;

FIG. 8 is a block diagram illustrating components of the SATA interface and flash memory interface of FIG. 4; and

FIG. 9 is a flowchart illustrating exemplary operations for updating the programming of an electronic system using a SATA interface according to some embodiments of the present invention.

### DETAILED DESCRIPTION OF EMBODIMENTS OF THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the scope of the invention to those skilled in the art. Throughout the drawings, like reference numerals refer to like elements.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

It will also be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention.

The terminology used in the description of the invention herein is for the purpose of describing particular embodiments only and is not intended to be limiting of the invention. As used in the description of the invention and the appended claims, the singular forms “a”, “an “and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The present invention is described below with reference to block diagrams and/or flowchart illustrations of systems, devices, and/or methods according to embodiments of the invention. It should be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

Unless otherwise defined, all terms used in disclosing embodiments of the invention, including technical and scientific terms, have the same meaning as commonly understood by one of ordinary skill in the art to which this invention belongs, and are not necessarily limited to the specific definitions known at the time of the present invention being described. Accordingly, these terms can include equivalent terms that are created after such time. It will be further understood that terms, such as those defined in commonly used dictionaries, should be interpreted as having a meaning that is consistent with their meaning in the present specification and in the context of the relevant art and will not be interpreted in an idealized or overly formal sense unless expressly so defined herein. All publications, patent applications, patents, and other references mentioned herein are incorporated by reference in their entirety.

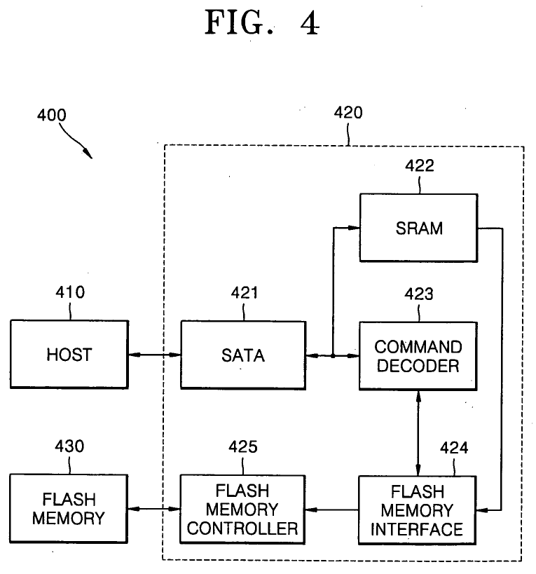

FIG. 4 is a block diagram of an apparatus configured to update firmware and/or other programming of an electronic device, such as a disk drive, using a Serial Advanced Technology Attachment (SATA) interface according to some embodiments of the present invention. Referring now to FIG. 4, an electronic system 400 includes a host 410 connected to an SRAM 422 and a command decoder 423 via a SATA interface 421. The command decoder 423 is connected to a flash memory interface 424. The command decoder 423 generates signals for controlling a flash memory 430 and transmits the signals to a flash memory controller 425.

The SATA interface 421 includes four data pins per channel: two receiving-dedicated data pins, and two transmission-dedicated data pins. A program configured for driving the optical system 400 is loaded into the SRAM 422 from the host 410. The command decoder 423 may interpret the type of frame information structure (FIS) of a SATA protocol received via the SATA interface 421, for example, using a vendor specific method.

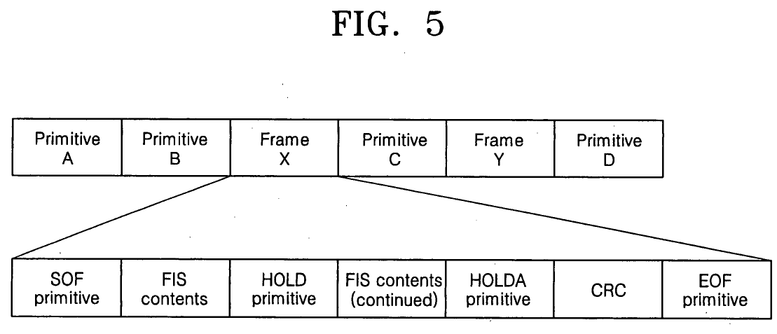

In an SATA protocol according to some embodiments of the present invention, information is provided on a serial line using 8-bit/10-bit encoded characters. The smallest unit of communication may be a double word Dword. The contents of double words may be grouped in order to provide low-level control information and/or transmit information between a host and an attached device. FIG. 5 illustrates a transmission sequence for a SATA protocol according to some embodiments of the present invention. Referring to FIG. 5, primitives (for example, 4-byte sequences) may be used to transmit real-time status information for serial lines, control transmission of information, and/or regulate communication between the host and devices. A frame may include multiple double words, starting with an SOF (Start of Frame) primitive followed by a user payload (FIS contents), and ending with CRC (cyclical redundancy check) and EOF (End of Frame) primitives.

The command decoder 423 is configured to interpret a register host-to-device FIS and a data host-to-device and/or device-to-host FIS to generate flash memory control signals.

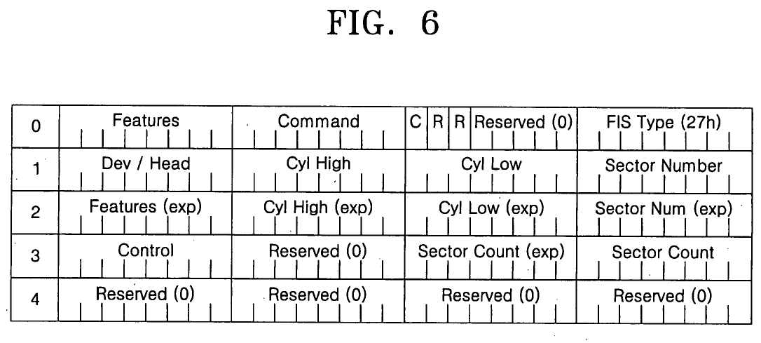

FIG. 6 illustrates a layout of register host-to-device FIS in a SATA protocol according to some embodiments of the present invention. A detailed description of the FIS of FIG. 6 will now be provided. As shown in FIG. 6, the FIS type is set to 27 h, and the FIS length is defined as 5 double words. Features include the contents of a feature register of a shadow register block, and Command includes the contents of a command register of the shadow register block. In addition, C is set to 1 when the command register is updated, and C is set to 0 when a device control register is updated. R and Reserved are set to 0 in reserve. Cyl High includes the contents of a cylinder high register of the shadow register block, and Cyl Low includes the contents of a cylinder low register of the shadow register block. Sector number includes the contents of a sector number register of the shadow register block, Control includes the contents of the device control register of the shadow register block, and Sector count includes the contents of a sector counter register of the shadow register block. Features (exp), Cyl High (exp), Cyl Low (exp), Sector number (exp) and Sector count (exp) include the contents of expanded address fields of the shadow register block.

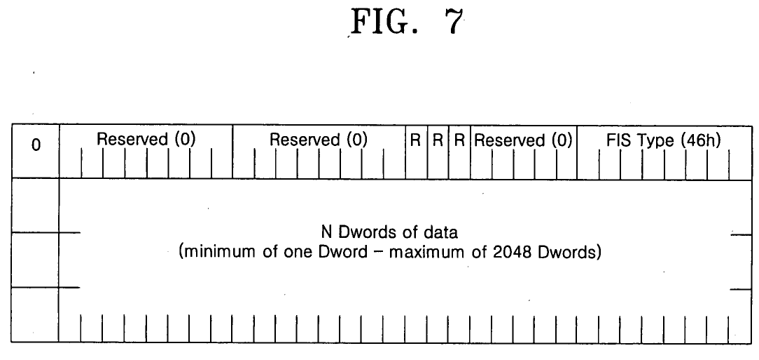

FIG. 7 illustrates a layout of data host-to-device/device-to-host FIS in a SATA protocol according to some embodiments of the present invention. A detailed description of the FIS of FIG. 7 will now be provided. Referring to FIG. 7, FIS type is set to 46 h, and FIS length is defined as N+1 double words. N Dwords of data includes actual data to be transmitted. In the FIS of FIG. 7, the quantity of data to be transmitted may not exceed maximum 2048 double words (8192 bytes), and R is set to 0 in reserve.

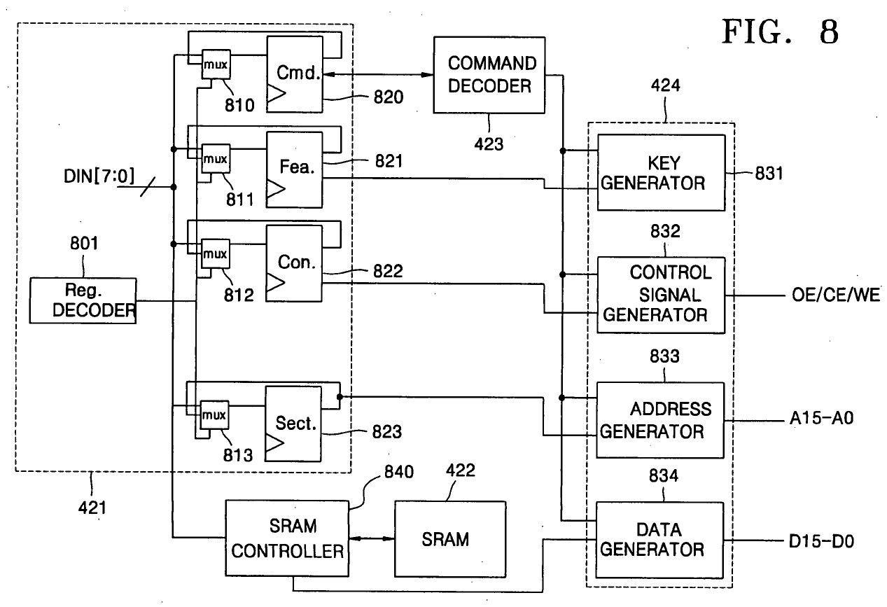

FIG. 8 is a block diagram illustrating components of the SATA interface 421 and flash memory interface 424 of the optical system 400 of FIG. 4. Referring now to FIG. 8, the SATA interface 421 stores an input signal DIN[7:0] (which may be 8-bit/10-bit encoded) in latches 820, 821, 822 and 823 via multiplexers 810, 811, 812 and 813, respectively, in response to a signal from a register decoder 801. The first latch 820 stores the command information from the register host-to-device FIS, the second latch 821 stores the feature information from the register host-to-device FIS, the third latch 822 stores the control information from the register host-to-device FIS, and the fourth latch 823 stores the sector number information from the register host-to-device FIS.

Still referring to FIG. 8, the command information stored in the first latch 820 is provided to the command decoder 423 to be interpreted. The command decoder 423 is connected to the flash memory interface 424, which is configured to generate the flash memory control signals. The flash memory interface 424 includes a key generator 831 configured to receive the feature information stored in the second latch 821, a control signal generator 832 configured to receive the control information stored in the third latch 822, and an address generator 833 configured to receive the sector number information stored in the fourth latch 823. The flash memory interface 424 further includes a data generator 834 configured to receive data stored in the SRAM 422 through an SRAM controller 840. The SRAM 422 stores data information from the data host-to-device/device-to-host FIS received as the input signal DIN[7:0].

The key generator 831 generates the ID of a flash memory to be updated, and the control signal generator 832 converts the control information in response to the command decoder 423 to generate an output enable signal OE, a chip enable signal CE and a write enable signal WE. The address generator 833 generates address signals A15 through A0 from the sector number information in response to the command decoder 423. The data generator 836 generates data signals D15 through D0 from the data stored in the SRAM 422.

Referring back to FIG. 4, the flash memory controller 425 checks the flash memory ID generated by the flash memory interface 424, and then instructs the flash memory 430 to perform initialization, erase and read or write operations in response to the output enable signal OE, chip enable signal CE and write enable signal WE.

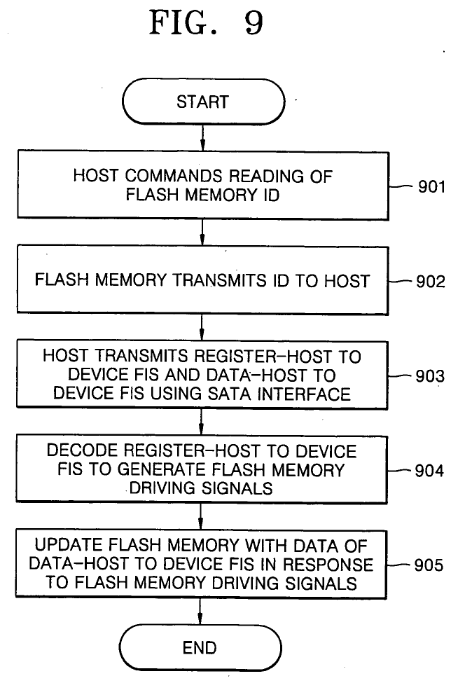

FIG. 9 is a flowchart illustrating exemplary operations for updating the programming of an optical system using a SATA interface according to some embodiments of the present invention. Referring to FIG. 9, when the host commands reading of the flash memory ID (block 901), the flash memory transmits its ID to the host (block 902). The host transmits the register host-to-device FIS and data host-to-device/device-to-host FIS using the SATA interface (block 903).

The register host-to-device FIS is decoded to generate flash memory driving signals (block 904). More specifically, the feature information of the register host-to-device FIS is decoded to generate an upgrade initialization key signal, and the control information of the register host-to-device FIS is decoded to generate control signals. In addition, the sector number information of the register host-to-device FIS is decoded to generate address signals. The data of the data host-to-device FIS is stored in the SRAM. Subsequently, the flash memory is updated with the data stored in the SRAM in response to the flash memory driving signals (block 905).

While the present invention has been particularly shown and described with reference to exemplary embodiments thereof, it will be understood by those of ordinary skill in the art that various changes in form and details may be made therein without departing from the spirit and scope of the present invention as defined by the following claims.

That which is claimed is:

1. An apparatus for updating program code of an electronic device using Serial Advanced Technology Attachment (SATA), comprising:
a SATA interface connected to a host and configured to receive input signals comprising a register host-to-device frame information structure (FIS) and a data host-to-device FIS therefrom;
a first memory connected to the SATA interface and configured to store program data obtained from the data host-to-device FIS;
a command decoder connected to the SATA interface and configured to interpret information obtained from the register host-to-device FIS; and
a second memory coupled to the command decoder and configured to be updated with the program data stored in the first memory responsive to an output of the command decoder.

2. The apparatus of claim 1, wherein the SATA interface comprises:
a plurality of multiplexers respectively configured to transmit command information, feature information, control information, and/or sector number information of the register host-to-device FIS; and
a plurality of latches respectively configured to store the command information, feature information, control information, and/or sector number information transmitted from the plurality of multiplexers.

3. The apparatus of claim 2, wherein the command decoder is configured to decode the command information of the register host-to-device FIS.

4. The apparatus of claim 2, further comprising a second memory interface connected to the second memory, the second memory interface comprising:
a key generator connected to one of the plurality of latches that is configured to store the feature information, wherein the key generator is configured to decode the feature information to generate an upgrade initialization key signal;
a control signal generator connected to one of the plurality of latches that is configured to store the control information, wherein the control signal generator is configured to decode the control information to generate control signals;
an address generator connected to one of the plurality of latches that is configured to store the sector number information, wherein the address generator is configured to decode the sector number information to generate address signals; and
a data generator connected to the first memory, wherein the data generator is configured to generate data signals from the program data stored in the first memory.

5. The apparatus of claim 1, wherein the first memory comprises static random access memory (SRAM).

6. The apparatus of claim 1, wherein the second memory comprises flash memory.

7. The apparatus of claim 1, wherein the electronic device comprises an optical disk drive.

8. The apparatus of claim 7, wherein the optical disk drive comprises a CD-ROM drive and/or a DVD drive.

9. An apparatus for updating program code in a disk drive using Serial Advanced Technology Attachment (SATA), comprising:
a SATA interface connected to a host and configured to receive input signals comprising a register host-to-device frame information structure (FIS) and a data host-to-device FIS therefrom;
a first memory connected to the SATA interface and configured to store program data from the data host-to-device FIS;
a command decoder connected to the SATA interface and configured to interpret information from the register host-to-device FIS;
a second memory configured to be updated with the program data stored in the first memory in response to a driving signal; and
a second memory interface connected to the second memory and configured to generate the driving signal responsive to an output of the command decoder based on the register host-to-device FIS,
wherein the second memory interface comprises:
a key generator configured to decode feature information of the register host-to-device FIS to generate an upgrade initialization key signal;
a control signal generator configured to decode control information of the register host-to-device FIS to generate control signals;
an address generator configured to decode sector number information of the register host-to-device FIS to generate address signals; and
a data generator that is connected to the first memory and is configured to generate data signals from the program data stored in the first memory.

10. The apparatus of claim 9, wherein the first memory comprises static random access memory (SRAM).

11. The apparatus of claim 9, wherein the second memory comprises flash memory.

12. The apparatus of claim 9, wherein the disk drive comprises an optical disk drive.

13. The apparatus of claim 12, wherein the optical disk drive comprises a CD-ROM drive and/or a DVD drive.

14. A method for updating program code in an electronic device using Serial Advanced Technology Attachment (SATA), comprising:
receiving SATA signals from a SATA interface;
decoding the SATA signals to determine whether a host computer system requests an upgrade of the program code;
receiving a register host-to-device frame information structure (FIS) and a data host-to-device FIS from the host computer system when the host computer system requests the upgrade of the program code;
storing data of the data host-to-device FIS in a first memory;
generating second memory driving signals responsive to receiving the register host-to-device FIS; and
writing the data of the data host-to-device FIS stored in the first memory in a second memory responsive to the second memory driving signals.

15. The method of claim 14, wherein the generating the second memory driving signals comprises:
decoding feature information of the register host-to-device FIS to generate an upgrade initialization key signal;
decoding control information of the register host-to-device FIS to generate control signals; and
decoding sector number information of the register host-to-device FIS to generate address signals.

16. The method of claim 14, wherein the first memory comprises SRAM.

17. The method of claim 14, wherein the second memory comprises flash memory.

18. The method of claim 14, wherein the electronic device comprises an optical disk drive.

19. The method of claim 14, wherein the optical disk drive comprises a CD-ROM drive and/or a DVD drive.

20. The method of claim 14, further comprising the following prior to receiving the SATA signals from the SATA interface:
requesting, by the host computer system, identification information from the second memory;
transmitting the identification information from the second memory to the host computer system; and
transmitting the SATA signals from the host computer system to the SATA interface.
